(19) United States
(12) Patent Application Publication
(10) Pub. No.: US 2012/0328887 A1
(43) Pub. Date: Dec. 27, 2012

(54) Method of fabricating insulated panels

(75) Inventors: Dale Ryan, Green Core Springs, FL (US); David Gauthier, New Salem, MA (US)

(73) Assignee: Vantem Composite Technologies, LLC.

(21) Appl. No.: 13/135,059

(22) Filed: Jun. 24, 2011

(51) Int. Cl. B32B 9/02; B29C 70/44; B05D 3/12

(52) U.S. Cl. 428/446; 427/372.2; 264/258

(57) ABSTRACT

A method for fabricating an insulated flame retardant panel includes the provision of a mixture of rice hulls and adhesive adhered to one or more skins of the panel with pressure in which the adhesive is either a urethane adhesive or a sodium silicate adhesive that is set by applying pressure, with the rice hulls providing an R value comparable to that associated with expanded polystyrene foam or urethane foam but with significantly improved structural properties and without involving environmentally unfriendly processes.

### FIELD OF THE INVENTION

This invention relates to a method for fabrication of structural insulated panels and more particularly to the utilization of rice hulls with adhesive as the insulative element attached to a skin or between two.

### BACKGROUND OF THE INVENTION

For the past 40 to 50 years structural insulated panels or SIPS primarily consist of two sheets of plywood or oriented strand board (OSB) separated by various thicknesses of either expanded polystyrene foam or urethane foam. Thus for instance a plywood composite sheet would be a 4×8 sheet of plywood to which is bonded a 4×8 sheet of foam, for instance to a thickness of 4 inches, followed by another sheet of plywood on the outside so that one has a 4×8 5 inch thick SIP panel.

Obviously expanded polystyrene foam is highly insulative and impervious for instance to water.

Note that foam panels of the type described are typically only used in 1% of the market due to cost. Note also that while the foam is only for instance 1 pound per cubic foot so that it is fairly light, the OSB skins are fairly thick such that the composite panel is heavy. For instance, a typical 4 inch thick SIP runs about 2 to 3 pounds per square foot. Note that oriented strand board refers to a type of plywood.

The main concern with such panels are in the way the foam is initially made. The foam is initially blown with CFCs or chloral floral chlorates that have global warming counterindications. Thus, CFC blown foam is environmentally unfriendly and is also highly flammable.

Additionally, nail panels or nail beds are provided with the aforementioned foam insulating material, with there being only one skin as opposed to the two skins associated with SIP panels. These single skin panels suffer from the same problems as those associated with the above-mentioned SIP panels. There is therefore a need for a better more environmentally safe and more cost effective insulated panel, be it a single skin or double skin panel.

### SUMMARY OF THE INVENTION

One of the ways to eliminate the problems with the foam composite panels and to reduce cost is to provide a product with rice hulls which are used as insulative structure and are molded with an adhesive in one embodiment mixing it with a binder of urethane or sodium silicate and applying pressure until the binder sets.

Note that the byproduct of milling the rice seed is a vast quantity of rice hulls that are in general opaloid in configuration. Moreover, rice hulls do not burn easily and are relatively impervious to insects and mold and mildew. Additionally, the shape of the rice hull once compacted lends itself to a cross section with a large number of little trapped air channels which makes the insulation capability of rice hulls and a binder that rivals that of expanded polystyrene foam. Thus a rice hull building panel held together with adhesives can be brought up to an R value rivaling expanded polystyrene foam.

It will be appreciated that the shape of the rice hulls is interesting in that their elongated football shape means that they can trap air in the middle of the structure.

Moreover, the rice hulls have little hairs or tongs coming off of the surfaces that act very much like Velcro so that they have a tendency to interlock when compressed which provides a considerable structural strength, whereas expanded polystyrene does not have such strength.

In summary, a method for fabricating an insulated flame retardant panel includes the provision of a mixture of rice hulls and adhesive adhered to one or more skins of the panel with pressure in which the adhesive is either a urethane adhesive or a sodium silicate adhesive that is set by applying pressure, with the rice hulls providing an R value comparable to that associated with expanded polystyrene foam or urethane foam but with significantly improved structural properties and without involving environmentally unfriendly processes.

### DETAILED DESCRIPTION

For laminated structures involving plywood for instance, one could place a plywood panel in the bottom of a mold to which is then added a mixture including the rice hulls and adhesive. Note that the important thing is to provide the exact amount of adhesive microscopically on the rice hulls so that they do not bind together in a monolithic structure. Too much adhesive and the rice hulls will be drenched and one loses the insulative capability.

Note that the adhesive in one case is sodium silicate which is mixed with rice hulls as described above and is poured into a mold, after which another sheet of plywood is put on top. The resulting structure is then held under pressure, with the pressure utilized in making the panel being between 2 and 5 PSI. In another case a nail base is made using only one skin to which is adhesively attached the rice hull mixture under similar pressures.

Regardless, the R value for the completed panel is comparable to expanded polystyrene.

While it has been suggested in a book called The Rice House by Paul Olivier that one use rice hulls between two pieces of plywood it is not at all clear how the panels would be mass produced. Moreover, no adhesives appear to have been used, with the rice hulls merely injected between opposed walls.

While not described in the article it is assumed that the rice hulls were hand tamped. However, there is no way to ascertain the R value by doing hand tamping.

Note that an extensive market exists for a structural panel with rice hulls replacing foam so that the structural ability, the load carrying ability, environmental safety and the like is enhanced even if one does not consider the insulation capabilities.

It will be appreciated that panels made with the rice hulls tend to be about 5 pounds per square foot because the rice hulls weigh more than the foam. However, the skins used can be made much thinner on the outside. The reason for this is because of the increased structural strength due to the rice hulls as compared to a weaker expanded polystyrene foam. Moreover, the mixing is indeed a critical factor, with it being found that blade speeds on the order of 1700 RPM provide the appropriate mixing with a mixing time between 1 and 2 minutes. In one embodiment for example the use of a Henschel high speed mixer provides the proper uniformity of adhives on the exterior of the rice hulls, reducing the amount of adhesive and increasing air voids. It will also be appreciated that the provision of a uniform adhesive coating can be achieved by spraying, a high intensity blade mixer or a rotational drum mixer. It will be noted that with appropriate experimentation the minimum amount of adhesive needed to achieve proper and uniform bonding can be obtained. By proper mixing, the ratio of adhesive to rice hulls can be below 20 weight percent.

Currently polystyrene foam SIP panels are sold at about $100 a piece for a 4×8 panel 4 inches thick, whereas panels made with rice hulls that are 4 inches thick and 4×8 can be made for instance at a 20% reduction in cost.

The reason that the subject process is unique over the prior use of rice hulls is that adhesive is used and because of the particular mixing that is used, as compared to hand tamping.

Moreover, in one embodiment, the panels made in the subject invention are fabricated in a continuous process as opposed to a batch process in which a laminator line is utilized. A laminator line allows continuous injection of the rice hull adhesive mixture allowing high speed continuous production of single skinned or double skinned panels. Note that what Paul Olivier describes is nothing more than providing rice hull insulation for an existing home and the technique is not suitable for use in manufacturing of a building panel.

By way of example, in one embodiment 7.5 cubic yards of rice hulls are mixed with 10% adhesive by volume or 5.6 gallons. The adhesive utilized in this embodiment is a urethane binder manufactured by Ashland Chemical.

The rice hulls and adhesive are mixed in a Henschel high shear mixer for 90 seconds.

A 4 foot by 8 foot oriented strand board is placed at the bottom of a mold that is 4 feet by 8 feet by 5 inches deep. The mixed rice hulls and adhesive is poured on top of the oriented strand board. A second oriented strand board 4 feet by 8 feet is placed in the mold on top of the rice hull and adhesive mixture.

The mold and its contents are put in a vacuum bag press and pressed together uniformly for 1 hour at 10 psi pressure.

The panel is removed from the press with the two skins now tightly bound to the rice hull core as a structural insulated panel.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for fabricating insulated panels comprising the steps of:
forming a mixture of rice hulls and adhesive;
applying the rice adhesive mixture to a panel skin; and,
applying pressure to the mixture and the skin until the adhesive sets.

2. The method of claim 1, wherein the adhesive is in the form of a binder.

3. The method of claim 2, wherein the binder includes urethane.

4. The method of claim 2, wherein the binder includes sodium silicate.

5. The method of claim 1, wherein the ratio of adhesive to rice hulls is below 20 weight percent.

6. The method of claim 1, wherein the mixing is accomplished utilizing a high sheer mixer.

7. The method of claim 6, wherein the high sheer mixer mixes the adhesive and the rice hulls at a blade speed of 1700 rpm.

8. The method of claim 7, wherein the mixing time is 90 seconds.

9. The method of claim 1, wherein the mixing time is between 1 and 2 minutes.

10. The method of claim 1, wherein the panel is a structural insulated panel having two skins with the rice hull and adhesive mixture therebetween.

11. The method of claim 1, wherein the insulated panel is a nail panel having a single skin with the rice hull adhesive mixture adhered to the surface of the single skin.

12. The method of claim 1, wherein the rice hulls are mixed with 10% adhesive and wherein the adhesive is a urethane binder.

13. The method of claim 12, wherein 7.5 cubic yards of rice hulls are mixed with 5.6 gallons of adhesive.

14. The method of claim 13, wherein the rice hulls and adhesive are mixed in a high sheer mixer for 90 seconds.

15. The method of claim 1, wherein the insulated panel is made by placing an oriented strand board in the bottom of a mold, wherein the mixed rice hulls and adhesive is poured on top of the oriented strand board and wherein a second oriented strand board is placed on top of the rice hull adhesive mixture, the mold and its contents being placed in a vacuum bag and pressed uniformly together for 1 hour at 10 psi, the result being a two skin panel tightly bound to a rice hull core to form a structural insulated panel.

16. A panel made in accordance with the method of claim 1.
